(19) United States
(12) Patent Application Publication
(10) Pub. No.: US 2025/0358041 A1
(43) Pub. Date: Nov. 20, 2025

(54) CODE BLOCK GROUP CONFIGURATION TECHNIQUES

(71) Applicant: QUALCOMM Incorporated, San Diego, CA (US)

(72) Inventors: Aviv REGEV, Tel Aviv (IL); Shay LANDIS, Hod Hasharon (IL); Ronen SHAKED, Kfar Saba (IL); Amit MOSES, Tel Aviv (IL)

(21) Appl. No.: 18/665,237

(22) Filed: May 15, 2024

(51) Int. Cl. H04L 1/00

(52) U.S. Cl. CPC H04L 1/0009; H04L 1/0057

(57) ABSTRACT

Certain aspects of the present disclosure provide techniques for techniques for code blocks groups (CBGs) configuration for wireless communications. An example method by a user equipment (UE) includes receiving, from a network entity, an indication of a policy for determining a code block group (CBG) configuration for a first transport block (TB), wherein the indicated policy indicates at least a channel metric for determining the CBG configuration, determining the indicated channel metric based on the indicated policy and one or more channel measurements, and transmitting, to the network entity, an indication of the CBG configuration, wherein the CBG configuration is based on the determined channel metric.

### BACKGROUND

### Field of the Disclosure

Aspects of the present disclosure relate to wireless communications, and more particularly, to techniques for code blocks groups (CBGs) configuration for wireless communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects can be implemented in a method for wireless communication performed by a user equipment (UE). The method includes receiving, from a network entity, an indication of a policy for determining a code block group (CBG) configuration for a first transport block (TB), wherein the indicated policy indicates at least a channel metric for determining the CBG configuration, determining the indicated channel metric based on the indicated policy and one or more channel measurements, and transmitting, to the network entity, an indication of the CBG configuration, wherein the CBG configuration is based on the determined channel metric.

Certain aspects can be implemented in a method for wireless communication performed by a network entity. The method includes transmitting, to a user equipment (UE), an indication of a policy for determining a code block group (CBG) configuration for a first transport block (TB), wherein the indicated policy indicates at least a channel metric for determining the CBG configuration and receiving, from the UE, an indication of the CBG configuration, wherein the CBG configuration is based on the indicated channel metric.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates an example non-terrestrial network.

FIGS. 5B and 5C illustrate different non-terrestrial network architectures.

FIG. 6 illustrates an example transport block (TB).

FIGS. 7A and 7B illustrate a code block error ratio (CBER) curves of a wireless channel.

FIG. 8 is call flow diagram illustrating example operations between a network entity and a user equipment.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums techniques for code blocks groups (CBGs) configuration for wireless communications.

Information may be transmitted from a network entity to a user equipment (UE) in a transport block (TB) composed of a quantity of code blocks. In some cases, the UE may be configured to provide feedback, known as acknowledgment (ACK)/negative-acknowledgement (NACK) indications. Traditionally, the UE may provide one ACK/NACK indication per TB. However, this lead to issues in which when even one code block of the TB failed to be correctly decoded by the UE, the UE would be required to provide a NACK indication to the network entity, which would trigger retransmission of the entire TB, which needlessly consumed a significant amount of time-frequency resources within the wireless communication system.

More recently, to avoid the scenarios in which the entire TB has to be retransmitted when even just one CB fails decoding, wireless communication systems have implemented the use of code block groups (CBGs) when providing feedback. For example, a TB may be divided into a plurality of CBGs, each including a quantity of CBs of the TB, and a respective ACK/NACK indication may be provided for each CBG of the TB. Accordingly, a CB of the TB fail decoding at a UE, the UE may provide a NACK indication for the CBG corresponding to the failed CB, allowing the network entity to only have to retransmit the CBG for which the NACK indication has been received rather than having to retransmit the entire TB.

As can be seen, providing a respective ACK/NACK indication for each CBG of a TB may slightly increase overhead (e.g., time-frequency resource usage) when transmitting feedback information for the TB by the quantity of CBGs included within the TB. However, this slight increase in overhead associated with providing an ACK/NACK indication for each CBG significantly improves retransmission efficiency associated with a TB by reducing the overhead associated with retransmissions of the TB by the network entity.

However, there may be some scenarios in which CBG-based ACK/NACK indications may not improve the retransmission efficiency of a TB while still increasing the overhead associated with providing the ACK/NACK indications. For example, there may be some scenarios in which channel conditions may cause all CBs of a TB to fail decoding at a UE. As such, in addition to having to provide an ACK/NACK indication for each CBG of the TB (e.g., due to the failed CBs), the network entity will also have to retransmit the entire TB anyway due to all of the failed CBs. As can be seen, in this scenario, due to the channel conditions, there is the increased overhead associated with all of the respective ACK/NACK indications provided for each CBG as well as the entire TB having to be retransmitted.

As such, in the scenario described above, it may be beneficial to reduce the quantity of CBGs per TB such that the UE does not have to provide as many ACK/NACK indication for CBGs that will ultimately fail decoding due to the channel conditions. However, channel conditions are not currently taken into account when configuring the CBG size, which may lead to the retransmission inefficiencies described above.

Accordingly, aspects of the present disclosure provide techniques for configuring a CBG size or quantity of CBGs per TB that takes into account channel conditions of a wireless channel between a network entity, such as a BS, and a UE. By taking the channel conditions into account when configuring the CBG size or quantity of CBGs per TB, the scenarios described above in which the network entity has to retransmit an entire TB and in which the UE has to transmit a significant amount of ACK/NACK indications may be reduced.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

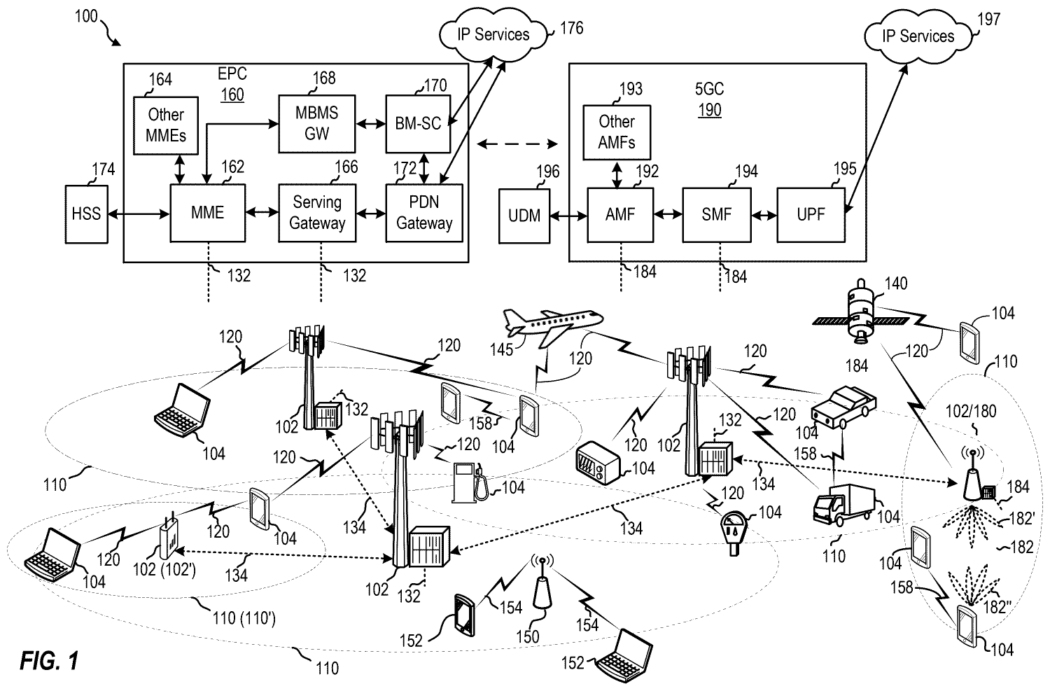

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

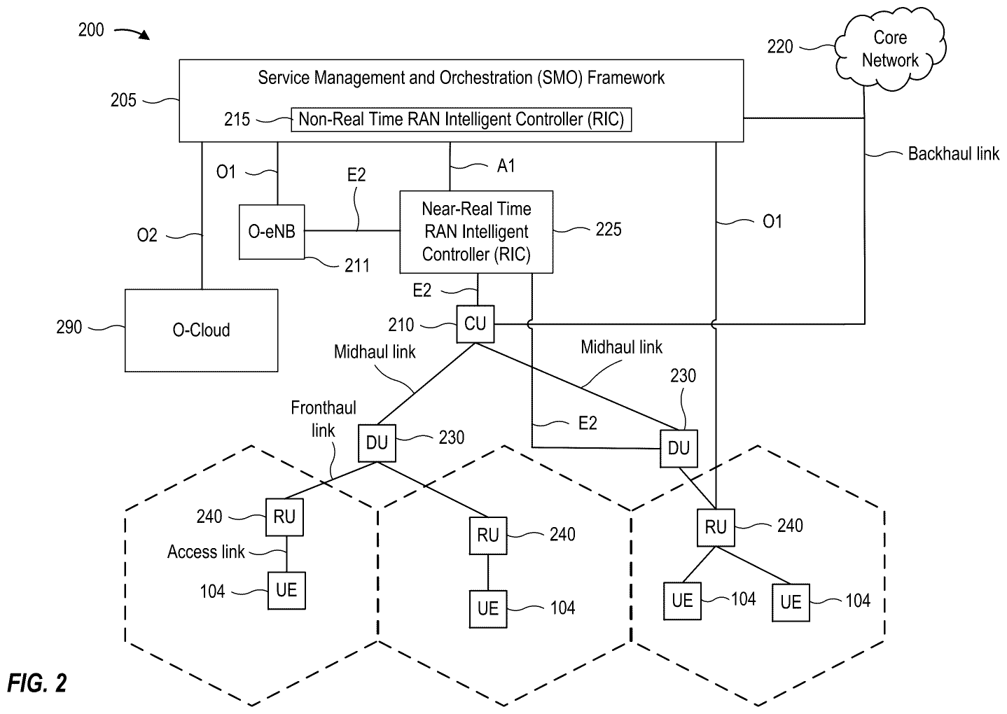

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

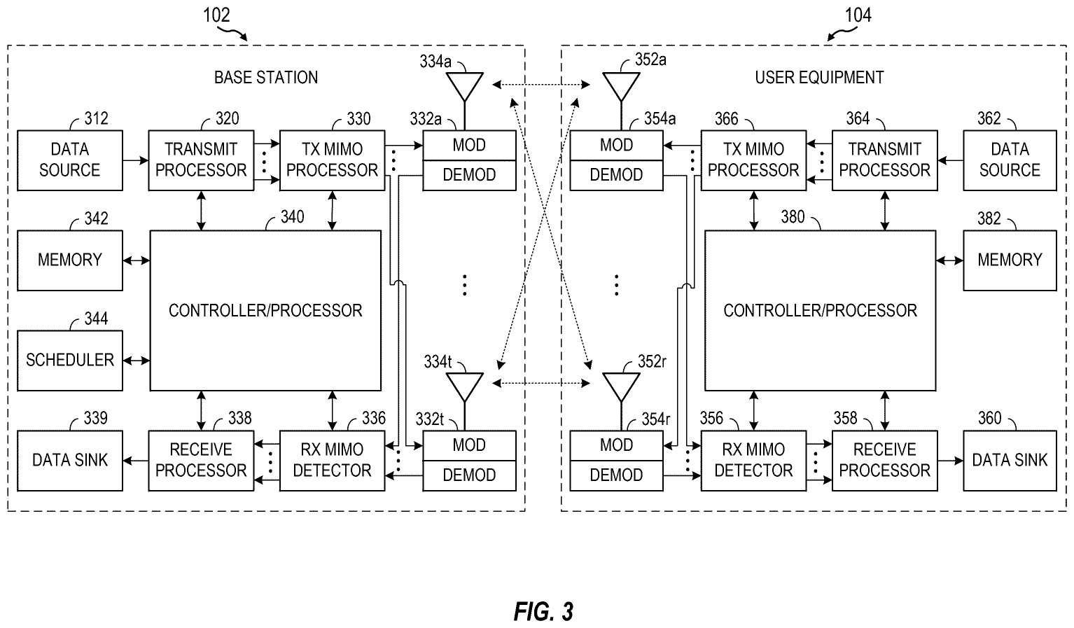

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

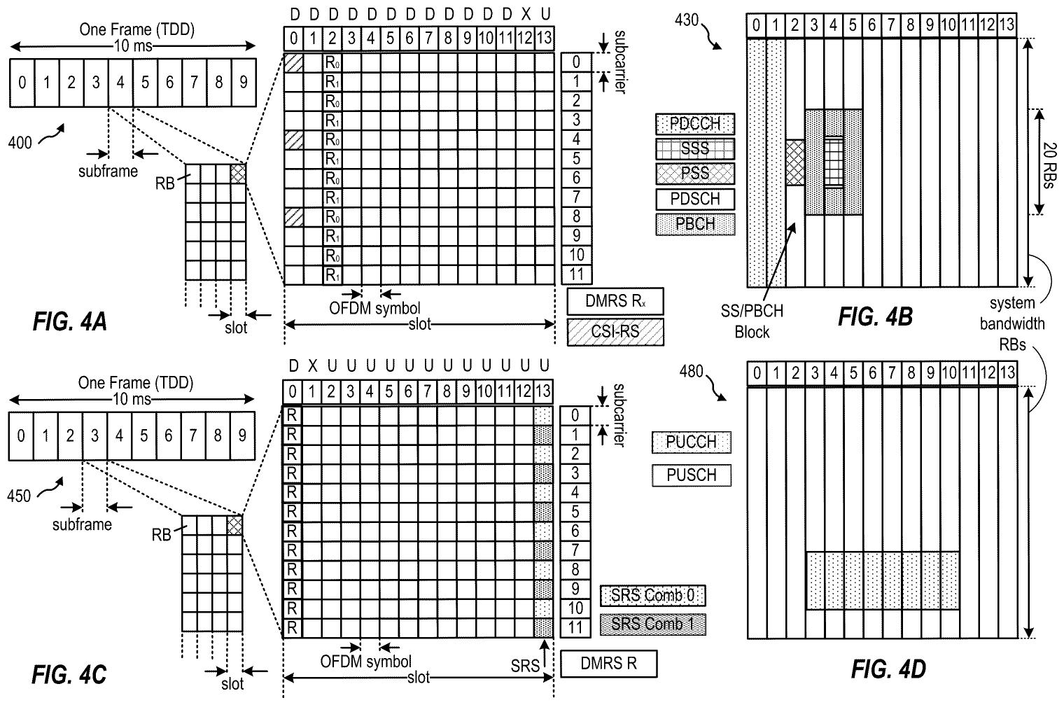

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2μ slots/subframe. The subcarrier spacing and symbol length/duration are a function of the numerology. The subcarrier spacing may be equal to 2×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Non-Terrestrial Networks

In some cases, communication in a wireless communication network, such as the wireless communication network 100 illustrated in FIG. 1, may be facilitated by one or more non-terrestrial (NT) devices. In such cases, this wireless communication network may be referred to as a NT network (NTN). NT devices may include, for example, devices such as a space satellite (e.g., satellite 140 illustrated in FIG. 1), a balloon, a dirigible, an airplane, a drone, an unmanned aerial vehicle, and/or the like.

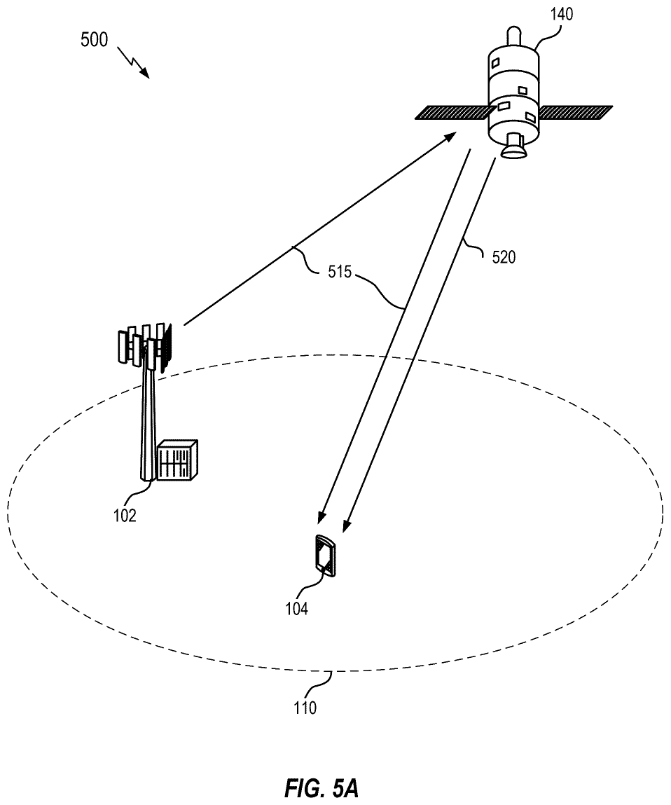

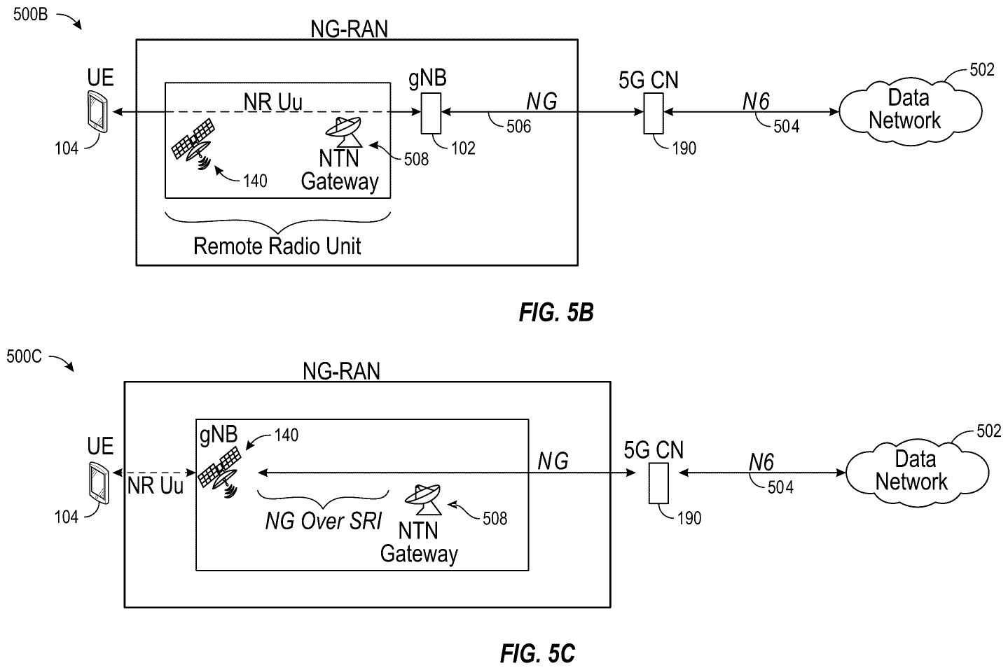

FIG. 5A illustrates an example of an NTN 500A including satellite 140, in which aspects of the present disclosure may be practiced. In some examples, the NTN 500A may implement aspects of the wireless communication network 100. For example, the NTN 500A may include BS 102, UE 104, and satellite 140. BS 102 may serve a coverage area or cell 110 in cases of a terrestrial network, and satellite 140 may serve the coverage area or cell 110 in cases of an NTN. Some NTNs may employ airborne platforms (e.g., a drone or balloon) and/or space borne platforms (e.g., a satellite).

The satellite 140 may communicate with the BS 102 and UE 104 as part of wireless communications in the NTN 500A. In cases of a terrestrial network, the UE 104 may communicate with the BS 102 over a communication link (e.g., communication link 120 in FIG. 1). In the case of NTN wireless communications, the satellite 140 may be the serving cell for the UE 104 via a communication links 520 (e.g., communication link 120 in FIG. 1). In certain aspects, the satellite 140 may act as a relay for the BS 102 and the UE 104, relaying both data transmission and control signaling 515.

The UE 104 may determine to connect to the satellite 140 using a random access (RA) procedure (e.g., a four-step RA procedure or a two-step RA procedure). The initiation of the RA procedure may begin with the transmission of a RA preamble (e.g., an NR preamble for RA) by the UE 104 to the satellite 140 or BS 102. The UE 104 may transmit the RA preamble on a physical random access channel (PRACH). In some PRACH designs, there may be no estimation or accounting for the RTD or the frequency shift associated with NTNs. In certain networks, such as terrestrial NR networks (e.g., 5G NR), SSBs transmitted by a cell are transmitted on the same frequency interval (e.g., occupying the same frequency interval). In NTN, a satellite may use multiple antennas to form multiple narrow beams and the beams may operate on different frequency intervals to mitigate interference among the beams.

In some cases, different architectures may exist for NTNs, such as a transparent satellite based NTN architecture and a regenerative satellite based NTN architecture. An example of the transparent satellite based NTN architecture is illustrated in FIG. 5B while an example of the regenerative satellite based NTN architecture is illustrated in FIG. 5C. In some cases, the NTN architectures shown in FIGS. 5B and 5C may be implemented in the NTN 500A shown in FIG. 5A.

In general, the transparent satellite based NTN architecture (e.g., also known as a bent-pipe satellite architecture, such as depicted in FIG. 5B) involves the satellite 140 receiving a signal from a BS 102 and relaying the signal to a UE 104 or another BS 102, or vice-versa. In the regenerative satellite based NTN architecture (such as depicted in FIG. 5C), satellite 140 may be configured to relay signals like the bent-pipe transponder or satellite, but may also use on-board processing to perform other functions, such as demodulating a received signal, decoding a received signal, re-encoding a signal to be transmitted, or modulating the signal to be transmitted, or a combination thereof.

For example, as shown in FIG. 5B, in a transparent satellite based NTN architecture 500B, communication between a UE 104 and a data network (DN) 502 may begin with data being sent from the DN 502 over a communication link 504 to user plane function (UPF) in a 5G core network (5G CN), such as the UPF 195 in 5GC 190 illustrated in FIG. 1. In some cases, the communication link 504 between the DN 502 and the UPF in the 5GC 190 may be associated with an N6 interface. Thereafter, the data may be forwarded from the 5GC 190 to BS 102 via a communication link 506 associated with an NG interface. The data may then be sent by the BS 102 to the UE 104 on a new radio (NR) Uu interface via an NTN gateway 508 and satellite 140. For example, the NTN gateway 508 may receive the data from the BS 102 and may forward the data to the satellite 140 on a feeder link via a satellite radio interface (SRI). The SRI on the feeder link is the NR Uu interface. Thereafter, the satellite 140 may perform radio frequency filtering, frequency conversion, and amplification on the received data before relaying the data to the UE 104 on a service link. Hence, the satellite 140 in the transparent satellite based NTN architecture 500B merely repeats the data on the NR-Uu radio interface from the feeder link (e.g., between the NTN gateway 508 and the satellite 140) to the service link (e.g., between the satellite 140 and the UE 104) and vice versa. In other words, the data is un-changed by the satellite 140 and is simply relayed to the UE 104.

In the regenerative satellite based NTN architecture 500C illustrated in FIG. 5C, the data from the DN 502 may be sent from the 5G CN directly to the satellite 140 via NTN gateway 508 without first being processed by BS 102. For example, the NTN gateway 508 may send the data to the satellite 140 on a feeder link that implements an SRI interface. After receiving the data, the satellite 140 may perform radio frequency filtering, frequency conversion and amplification as well as demodulation/decoding, switch and/or routing, coding/modulation. This is effectively equivalent to having all or part of BS 102 functions (e.g. gNB) on board the satellite 140. Thereafter, the satellite 140 transmits the data to the UE 104 on an NR-Uu radio interface via a service link between the UE 104 and the satellite 140.

### Aspects Related to Code Block Group (CBG) Configuration Techniques

Wireless communication systems rely on the transmission of data in discrete units known as transport blocks (TBs), which may be transmitted by a base station (BS), such as BS 102, and received by a user equipment (UE), such as UE 104. These TBs may include a plurality of code blocks (CBs) that encapsulate information to be transmitted over the air, forming the backbone of communication in modern wireless networks. Ensuring the reliable delivery of TBs is crucial for maintaining seamless connectivity and efficient data transfer. However, in the dynamic and often unpredictable wireless environment, transmission errors can occur, leading to decoding failures at a receiving end.

In traditional wireless communication standards like LTE, a straightforward approach is employed to handle decoding failures. For example, each TB may be associated with an acknowledgment (ACK) or negative acknowledgment (NACK) indication. Upon receiving a NACK indication from a UE that indicates that the UE failed to decode a TB, an LTE BS may retransmit the entire TB to the UE, including all constituent CBs, to rectify this decoding failure.

However, with the evolution of wireless technology, particularly in the context of 5G and beyond, the size of TBs has increased significantly to accommodate higher data rates and more diverse applications. This presents a challenge for the traditional retransmission approach as used in LTE, as the retransmission of entire TBs becomes inefficient and resource-intensive due to their increased size.

To address this challenge, an advanced approach has been implemented in 5G networks. For example, instead of associating ACK/NACK indications with individual TBs, the constituent CBs of a TB may be divided by a 5G BS into different code block groups (CBGs), and ACK/NACK indications may be provided by the UE for each different CBG of the TB.

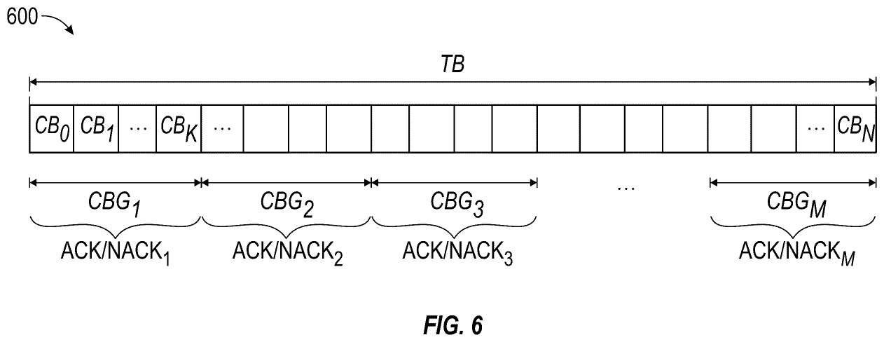

For example, as shown in FIG. 6, a TB 600 may include a plurality (e.g., N) of CBs, labeled CB₀, CB₁, CB_{K}, . . . , CB_{N}. Further, as shown, the plurality of CBs may be divided into a plurality of CBGs. For example, each CBG may include a quantity K of CBs, resulting in a quantity M of CBGs (e.g., M=N/K), labeled CBG₀, CBG₁, CBG₃, . . . , CBG_{M}. Accordingly, in 5G wireless networks, rather than providing a single ACK/NACK indication for the TB 600 as a whole, a UE may instead be configured to provide a separate ACK/NACK indication for each CBG of the TB 600, resulting in M number of ACK/NACK indications being transmitted by the UE. Accordingly, as can be seen, this approach may allow the 5G BS to selectively retransmit only the specific CBGs that have been indicated as having decoding failures (e.g., the CBGs for which the 5G BS has received NACKs), rather than retransmitting the entire TB 600 and all CBs (e.g., N).

A size of a CBG (e.g., the quantity of CBs included within a CBG), which may indirectly indicate a quantity of CBGs included within on TB, plays a crucial role in transmission efficiency. If the CBG size is set too high, resulting in a small number of CBGs per TB, the BS may have to retransmit a significant amount of information or CBs when a decoding failure occurs, leading to increased resource usage. Conversely, if the CBG size is set too low, meaning a low number of code blocks per CBG, a large number of ACK/NACK indications may have to be transmitted, potentially causing overhead issues.

Currently, CBG size may be configured via radio resource control (RRC) signaling based on certain policies of the BS, which may be left up to implementation. In some cases, a BS may take into account additional overhead and latency per each additional CBG and an environment of a cell associated with the BS. However, such policies may not take into account channel conditions or channel metrics associated with a wireless channel over which information (e.g., TBs) are transmitted from the BS to the UE, which may result in transmission inefficiencies and lead to unnecessary consumption of time-frequency resources.

For example, in urban areas a wireless channel may consist of many non-line of site (NLOS) components or time domain taps. As a result, the wireless channel may experience time-domain/frequency-domain (TD/FD) fading, where channel conditions vary dynamically in both the TD and the FD. Consequently, some CBs of a transmitted TB may undergo successful decoding while others may fail. Employing a traditional approach in which the TB is not partitioned into a plurality of CBGs would trigger retransmission of the entire TB even if only one CB fails, despite the successful decoding of the remaining CBs. Thus, in such scenarios, there is a distinct advantage to configuring a small CBG size, resulting in the TB being partitioned into multiple small CBGs.

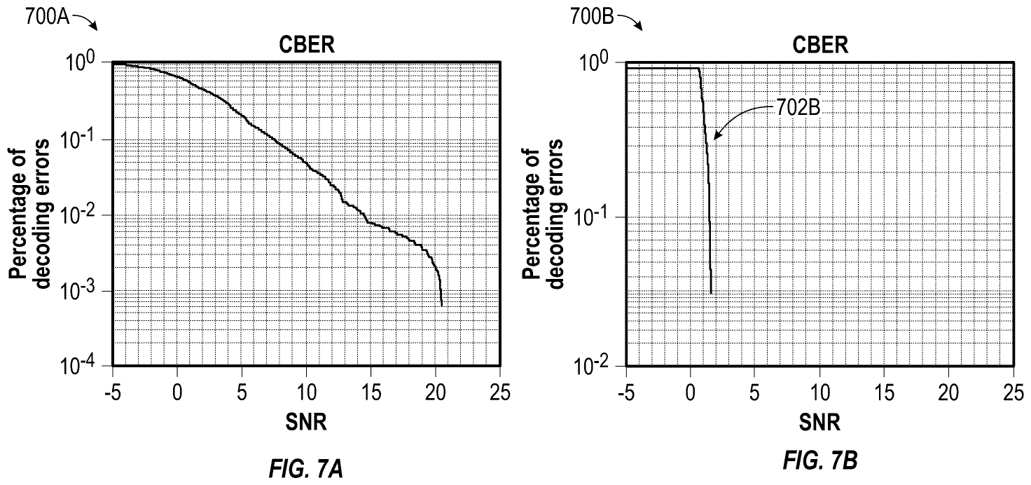

An example of this scenario is illustrated in FIG. 7A. For example, FIG. 7A includes a graph 700A illustrating a code block error ratio (CBER) curve of a wireless channel. The horizontal axis of the graph 700A depicts the channel conditions of the wireless channel, such as a signal to noise ratio (SNR), while the vertical axis of the graph 700A depicts a percentage of errors in decoding of CBs of a TB.

As can be seen, channel conditions (e.g., SNR) of the wireless channel depicted in the graph 700A may vary in the TD and FD. For example, as can be seen, due to TD/FD fading, as a slope of the CBER curve decreases from left to right in the graph 700A (e.g., due to the SNR of the wireless channel increasing from left to right), the percentage of errors in decoding decreases, resulting in some CBs of a TB being successfully decoded while other CBs of the TB failing decoding. In the scenario in which channel conditions of a wireless channel vary, such as depicted in FIG. 7A, there is a clear benefit to partition the TB into many CBGs and have many ACK/NACK indications. In fact, the more that the CBER curve slowly decays (e.g., representing higher varying channel conditions or a higher time/frequency fading wireless channel), the more CBGs in the TB that may be required.

In contrast, in rural areas or within a non-terrestrial network (NTN) like the NTN 500A described in FIG. 5A, the wireless channel typically exhibits a flat FD, resembling an additive white Gaussian noise (AWGN) channel with minimal time fading in the TD. In such scenarios, the channel conditions remain almost constant across both the TD and the FD. Consequently, if a TB fails decoding, it is likely that most CBs within the TB would also fail due to the stable channel conditions. Thus, dividing the TB into CBGs in such scenarios may be counterproductive since the majority of CBGs would likely experience decoding failure and require the UE to transmit a NACK indication, unnecessarily increasing overhead without enhancing retransmission efficiency.

An example of this scenario is illustrated in FIG. 7B. For example, FIG. 7B includes a graph 700B illustrating a CBER curve of a wireless channel. The horizontal axis of the graph 700B depicts the channel conditions of the wireless channel, such as SNR, while the vertical axis of the graph 700B depicts a percentage of errors in decoding of CBs of a TB. As shown in FIG. 7B, channel conditions (e.g., SNR) of the wireless channel may remain relatively constant in the TD and the FD, which may result in a “waterfall CBER” in which a slope of the CBER curve decreases significantly or “falls off,” as shown at 702B. In the case of failed decoding in this scenario, all CBs of a TB may fail decoding. As a result, in this scenario, there may be no added value to partition the TB to many CBGs since doing so will result in a large number of NACK indications being transmitted, increasing overhead without enhancing retransmission efficiency

As can be seen, channel conditions may affect a retransmission efficiency associated with CBGs in varying scenarios. However, channel conditions are not currently taken into account when configuring the CBG size, which may lead to the retransmission inefficiencies described above. For example, when channel conditions vary, such as described with respect to FIG. 7A, having too large of a CBG size (e.g., high number of CBs per CBG, resulting in a small quantity of CBGs per TB) may lead to the BS having to retransmit an entire TB, needlessly consuming time-frequency resources within a wireless network associated with this retransmission. Conversely, when channel conditions are stable, but poor, such as described with respect to FIG. 7B, having too small of a CBG size (e.g., low number of CBs per CBG, resulting in a large quantity of CBGs per TB) may lead to the UE having to provide a significant number of NACK indications, needlessly consuming time-frequency resources within the wireless network since when channel conditions are stable but poor, all CBs of the TB tend to fail decoding.

Accordingly, aspects of the present disclosure provide techniques for configuring a CBG size or quantity of CBGs per TB that takes into account channel conditions of a wireless channel between a network entity, such as a BS, and a UE. By taking the channel conditions into account when configuring the CBG size or quantity of CBGs per TB, the scenarios described above in which the network entity has to retransmit an entire TB and in which the UE has to transmit a significant amount of ACK/NACK indications may be reduced.

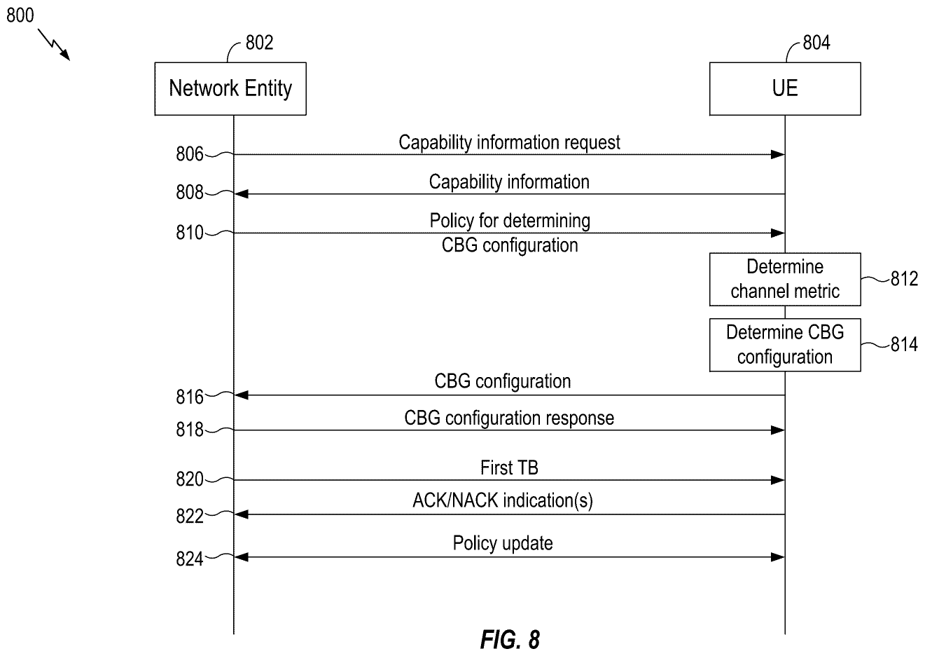

As will be described in greater detail below with respect to FIG. 8, these techniques may include the network entity providing a policy for determining a CBG configuration for a first TB. The policy may indicate a particular channel metric that the UE should use to determine the CBG configuration. The UE may then determine the channel metric based on the policy and one or more channel measurements, and transmit an indication of the CBG configuration to the network entity. The CBG configuration may indicate a quantity of CBs per CBGs or a quantity of CBGs per TB. The UE may then receive the first TB and provide a quantity of ACK/NACK indications equal to the quantity of CBGs.

### Example Operations of Entities in a Communications Network

FIG. 8 depicts a process flow including operations 800 for communications in a wireless network between a network entity 802 and a UE 804, for example, for configuring a quantity of CBGs per TB based on one or more channel metrics. In some aspects, the network entity 802 may be an example of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3. However, in other aspects, UE 804 may be another type of wireless communications device and network entity 802 may be another type of network entity or network node, such as those described herein.

Operations 800 begin at 806 with the UE 804 receiving, from the network entity 802, a first message requesting capability information of the UE 804 indicating a set of channel metrics that the UE is capable of determining. In some cases, the network entity 802 may transmit the first message to the UE 804 at a beginning of communication with the UE 804, such as during a random access channel (RACH) procedure. In some cases, the first message may be transmitted in a media access control-control element (MAC-CE) message.

At 808, the UE 804 may transmit a second message including the capability information of the UE indicating the set of channel metrics that the UE is capable of determining. For example, the set of channel metrics may include channel metrics such a CBER of a wireless channel between the network entity 802 and UE 804, a channel capacity of the wireless channel, a delay spread of the wireless channel, a mobility level of the UE 804, an SNR associated with the wireless channel, mutual information of a received signal and a transmitted signal, etc. In some cases, the second message may include a plurality of dedicated bits, each different dedicated bit of the plurality of dedicated bits corresponding to a different channel metric requested by the network entity 802. Accordingly, in some cases, the UE 804 may set each different dedicated bit to a particular bit value to signify whether the UE 804 is capable of determining the channel metric corresponding to that particular dedicated bit. In some cases, the second message may also be transmitted during the attachment procedure between the network entity 802 and UE 804, and may be transmitted in a MAC-CE.

At 810, the UE 804 may receive, from the network entity 802, an indication of a policy for determining a code block group (CBG) configuration for a first transport block (TB), wherein the indicated policy indicates at least a channel metric for determining the CBG configuration. In some cases, the network entity 802 may select the channel metric for determining the CBG configuration from the set of channel metrics that the UE is capable of determining. In some cases, the network entity 802 may transmit the indication of the policy for determining the CBG configuration in a physical (PHY) layer message, such as downlink control information (DCI).

In some cases, the indication of the policy comprises an index value to a look-up table (LUT) including a plurality of different policies for determining the CBG configuration. For example, in some cases, each policy included within the LUT may be indexed according to a particular index value and may indicate the channel metric for determining the CBG configuration. Additionally, in some cases, each policy may further provide a conservativity level for determining the CBG configuration. The conservativity level may indicate a quantity of CBGs of the first TB for the CBG configuration as a function of the channel metric. In some cases, the conservativity may be more or less conservative regarding the quantity of CBGs as a function of the channel metric. In some cases, the plurality of different policies in the LUT may be indexed, according to their corresponding conservativity levels, from least conservative to most conservative.

As an example, assuming that the channel metric comprises CBER, the quantity of CBGs may increase as an absolute value of a slope of the CBER decreases. Similarly, the quantity of CBGs may decrease as the absolute value of the slope of the CBER increases. The particular number of CBGs for a particular CBER slope, however, may be indicated by the particular conservativity level. For example, if the network entity 802 is more conservative, the network entity 802 may have a policy with a high conservativity level that indicates a quantity of CBGs greater than or equal to 5 CBGs for the particular CBER slope (e.g., which may lead to additional ACK/NACK overhead), whereas if the network entity 802 is less conservative, the network entity 802 may have a policy with a low conservativity level that indicates a quantity of CBGs less than 5 CBGs for the same particular CBER slope (e.g., which may save on the ACK/NACK overhead).

Table 1, below, provides an example of a first conservativity level for a CBER channel metric.

TABLE 1

| Average CBER Slope | # CBGs |
|---|---|
| slope > 3 | 1 |
| 2 < slope < 3 | 2 |
| 1.5 < slope < 2 | 3 |
| 1.1 < slope < 1.5 | 4 |
| 0.7 < slope < 1.1 | 5 |
| 0.4 < slope < 0.7 | 6 |
| 0.1 < slope < 0.4 | 7 |
| Slope < 0.1 | 8 |

As shown, for the first conservativity level, Table 1 indicates a plurality of different ranges associated with a channel metric, such as an average CBER slope. In some cases, the average CBER slope may be determined according to:

$$[ \frac{{log}_{10} ( p ( error ) )}{SNR} ] ,$$

where p(error) is the probability of an error in decoding of a code block and the signal to noise ratio (SNR) represents the ratio between a transmitted signal power of the code block and a noise power of a receive antenna of the UE.

Additionally, as shown, Table 1 indicates a corresponding quantity of CBGs for each different range of the plurality of different ranges associated with the channel metric. As can be seen, according to the first conservativity level, the quantity of CBGs may increase as the average CBER slope decreases. For example, for the first conservativity level, an average CBER slope of less than 0.1 may correspond to a quantity of CBGs equal to 8 CBGs. In another example, for a second conservativity level that is less conservative than the first conservativity level, the average CBER slope of less than 0.1 may correspond to a quantity of CBGs equal to 5 CBGs. Alternatively, for a third conservativity level, that is more conservative than the first conservativity level, the average CBER slope of less than 0.1 may correspond to a quantity of CBGs equal to 10 CBGs.

As shown at 812 in FIG. 8, the UE 804 may determine the channel metric indicated to the UE 804 in the policy received at 810 and based on one or more channel measurements. For example, the UE 804 may perform the one or more channel measurements on a wireless channel established between the network entity 802 and the UE 804. The UE 804 may then calculate the channel metric based on the one or more channel measurements.

Thereafter, as shown at 814, the UE 804 may determine the CBG configuration. For example, in some cases, the UE 804 may first determine the policy to use to determine the CBG configuration based on an index value provided to the UE at 810 and the LUT described above. The UE 804 may then determine the CBG configuration based on the determined channel metric and on a conservativity level indicated by the determined policy. For example, as noted above, the conservativity level may indicate a quantity of CBGs of the first TB for the CBG configuration as a function of the channel metric. As such, the UE 804 may determine the CBG configuration as a function of the indicated channel metric, for example, using the conservativity level. Accordingly, returning to the example described with respect to Table 1, above, assuming that the channel metric determined by the UE 804 comprises CBER, the UE 804 may determine which range, of the plurality of different ranges, that the slope of the CBER falls into and then may determine the quantity of CBGs corresponding to that the determined range. For example, based on the first conservativity level shown in Table 1, if the UE 804 determines that the slope of the CBER is between 0.4 and 0.7, then the UE 804 may determine the quantity of CBGs for the CBG configuration to be 6 CBGs.

As shown at 816, after determining the CBG configuration, the UE 804 may transmit, to the network entity 802, an indication of the CBG configuration, which, as discussed above, is based on the determined channel metric. In some cases, the UE 804 may indicate the CBG configuration using PHY layer signaling, such as in uplink control information (UCI).

In some cases, the CBG configuration may indicate the quantity of CBGs for the first TB determined by the UE 804 above. In some cases, the first TB may include a total number of CBs (e.g., N shown in FIG. 6). In such cases, based on the quantity of CBGs of the first TB and the total number of CBs of the first TB, the indication of the quantity of CBGs of the first TB may indicate a quantity of CBs per CBG. For example, with reference to FIG. 6, if the UE 804 indicates a quantity of CBGs equal to M CBGs, the network entity 802 may determine based on the total number CBs (e.g., N) known to the network entity 802, that each CBG may include K CBs, where K=N/M.

In some cases, the CBG configuration indicates a quantity of CBs per CBG. In this cases, based on the quantity of CBs per CBG and the total number of CBs of the first TB, the indication of the quantity of CBs per CBG indicates the quantity of CBGs of the first TB. For example, with reference to FIG. 6, if the UE 804 indicates a quantity of CBs per CBG equal to K CBs, the network entity 802 may determine, based on the total number CBs (e.g., N) known to the network entity 802, that the first TB includes a quantity of CBGs equal to M CBGs, where M=N/K.

After receiving the CBG configuration from the UE 804, the network entity 802 may decide to confirm or ignore the CBG configuration for the first TB received from the UE 804, in some cases, based on one or more requirements of the network entity 802 or one or more requirements of other UEs associated with the network entity 802, such as other UEs CBG configurations, latency requirements, additional overhead requirements, bandwidth availability, needs of a cell associated with the network entity 802, etc. The network entity 802 may then send a CBG configuration response message to the UE 804 at 818 in FIG. 8 that confirms or denies the CBG configuration that the UE 804 provided to the network entity 802. In some cases, the network entity 802 may send the CBG configuration response message in PHY layer signaling, such as DCI.

In some cases, in addition to improving retransmission efficiency based on the CBG configuration, the network entity 802 may be able to use the quantity of CBGs indicated in the CBG configuration to infer channel conditions between the network entity 802 and the UE 804 (e.g., more or less constant channel conditions based on more or less CBGs in the indicated quantity of CBGs).

Thereafter, as shown at 820, the UE 804 may receive the first TB from the network entity 802 based on or in accordance with the CBG configuration.

The UE 804 may then transmit one or more ACK/NACK indications based on the first TB, as shown at 822. For example, in some cases, the UE 804 may transmit a respective ACK or respective NACK for each CBG of the first TB. In some cases, when the network entity 802 confirms the CBG configuration, a quantity of respective ACK indications and respective NACK indications is equal to the quantity of CBGs of the first TB indicated in the CBG configuration. The UE 804 may continue to provide the quantity of respective ACK indications and respective NACK indications equal to the quantity of CBGs until the quantity of CBGs changes. In some cases, when the network entity 802 denies the CBG configuration, the UE 804 may fall back to a default quantity of CBGs for the first TB and may transmit the quantity of respective ACK indications and respective NACK indications accordingly.

As shown at 824, the network entity 802 and the UE 804 may engage in a policy update procedure to update the CBG configuration. In some cases, for example, the UE 804 may transmit a policy update request to the network entity 802, requesting that the policy for determining the CBG configuration be updated, based on the UE 804 entering/exiting a “low battery” mode, a “cooling down” mode, etc. In this case, operations 800 may return to 808 with the UE 804 transmitting updated capability information, updating the set of channel metrics that the UE 804 supports determining. In some cases, the network entity 802 may request that the UE 804 send the updated capability information, including the updated set of channel metrics, according to a particular periodicity. In some cases, the UE 804 may forego transmitting the policy update request message and simply transmit the updated capability information in step 808. In this case, the updated capability information may implicitly indicate to the network entity 802 to update the policy and transmit an indication of the updated policy in step 810.

Thereafter, the UE 804 may receive, from the network entity 802, an updated policy for determining an updated CBG configuration for a second TB. In some cases, the updated policy comprises an indication of at least one of (1) an updated channel metric for determining the updated CBG configuration or (2) an updated conservativity level for determining the updated CBG configuration. Once the UE 804 receives the updated policy from the network entity 802, operations 812, 814, 816, 818, 820, and 822 may be repeated.

In some cases, the network entity 802 may request that the UE 804 periodically determine the channel metric and periodically update the CBG configuration, including the quantity of CBGs per TB, based on the periodically determined channel metric.

In some cases, the network entity 802 may also autonomously update the policy based on system latency considerations, other UEs' requirements etc. In this case, operations 800 may return to 810 with the network entity 802 transmitting the updated policy for determining the CBG configuration to the UE 804. As noted above, the updated policy comprises an indication of at least one of (1) an updated channel metric for determining the updated CBG configuration or (2) an updated conservativity level for determining the updated CBG configuration. Once the UE 804 receives the updated policy from the network entity 802, operations 812, 814, 816, 818, 820, and 822 may be repeated.

In some cases, rather than updating the policy for determining the CBG configuration at 824, the network entity 802 and UE 804 may exchange signaling configuring the network entity 802 and UE 804 to return to a default mode in which a default quantity of CBGs for TBs may be used.

### Example Operations of a User Equipment

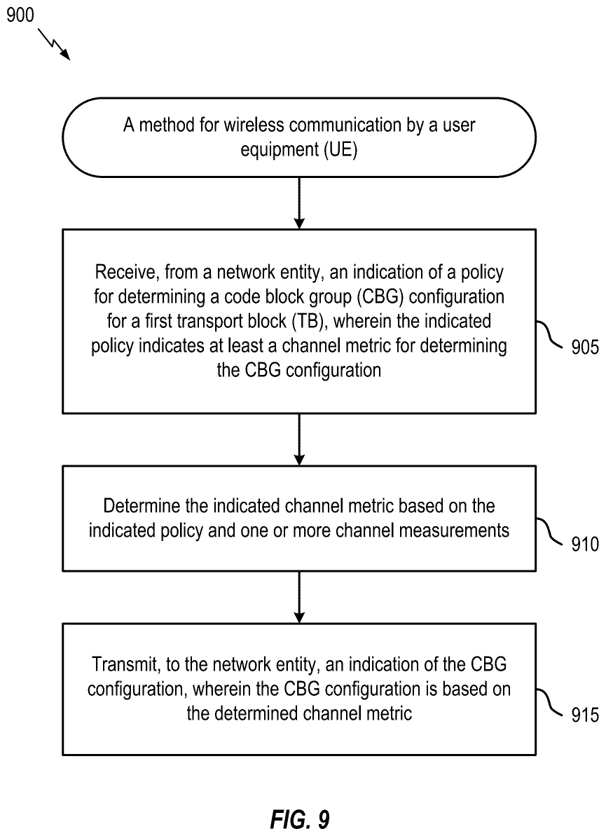

FIG. 9 shows an example of a method 900 of wireless communication at a user equipment (UE), such as a UE 104 of FIGS. 1 and 3.

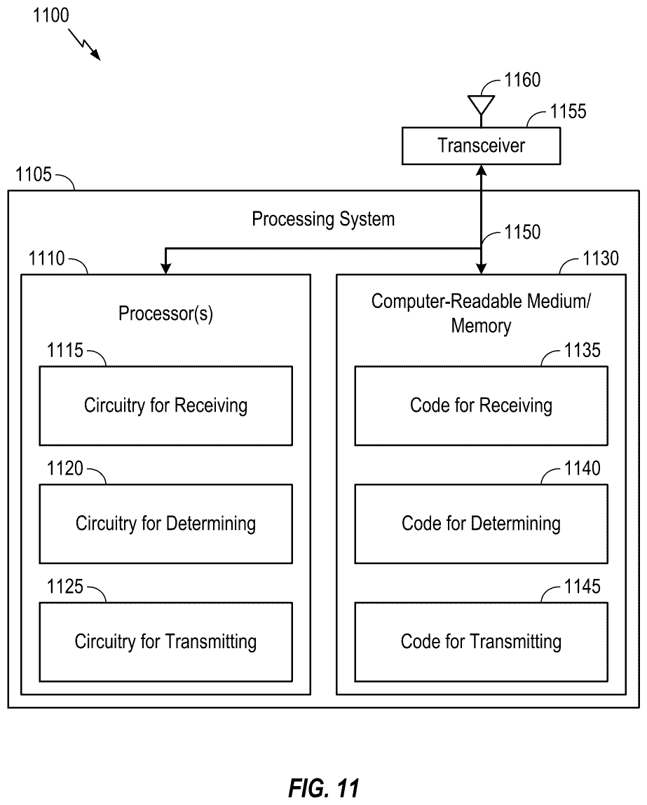

Method 900 begins at step 905 with receiving, from a network entity, an indication of a policy for determining a code block group (CBG) configuration for a first transport block (TB), wherein the indicated policy indicates at least a channel metric for determining the CBG configuration. In some cases, the operations of this step refer to, or may be performed by, circuitry for receiving and/or code for receiving as described with reference to FIG. 11.

Method 900 then proceeds to step 910 with determining the indicated channel metric based on the indicated policy and one or more channel measurements. In some cases, the operations of this step refer to, or may be performed by, circuitry for determining and/or code for determining as described with reference to FIG. 11.

Method 900 then proceeds to step 915 with transmitting, to the network entity, an indication of the CBG configuration, wherein the CBG configuration is based on the determined channel metric. In some cases, the operations of this step refer to, or may be performed by, circuitry for transmitting and/or code for transmitting as described with reference to FIG. 11.

In some aspects, the indicated channel metric comprises one of: a code block error ratio (CBER); a channel capacity; a delay spread; or a mobility level of the UE.

In some aspects, the method 900 further includes receiving, from the network entity, a first message requesting capability information of the UE indicating a set of channel metrics that the UE is capable of determining. In some cases, the operations of this step refer to, or may be performed by, circuitry for receiving and/or code for receiving as described with reference to FIG. 11.

In some aspects, the method 900 further includes transmitting a second message including capability information of the UE indicating the set of channel metrics that the UE is capable of determining. In some cases, the operations of this step refer to, or may be performed by, circuitry for transmitting and/or code for transmitting as described with reference to FIG. 11.

In some aspects, the indicated channel metric is based on the set of channel metrics.

In some aspects, the policy further provides a conservativity level for determining the CBG configuration; and the CBG configuration is further based on the conservativity level.

In some aspects, the conservativity level indicates: a plurality of different ranges of the channel metric; and a corresponding quantity of CBGs for each different range of the plurality of different ranges.

In some aspects, the conservativity level indicates a quantity of CBGs of the first TB for the CBG configuration as a function of the channel metric.

In some aspects, the indication of the policy comprises an index value to a look up table (LUT) including a plurality of different policies for determining the CBG configuration; and the method further comprises determining the policy based on the index value and the LUT.

In some aspects, the CBG configuration indicates a quantity of code blocks (CBs) per CBG.

In some aspects, the first TB includes a total number of CBs; and based on the quantity of CBs per CBG and the total number of CBs of the first TB, the indication of the quantity of CBs per CBG indicates a quantity of CBGs of the first TB.

In some aspects, the CBG configuration indicates a quantity of CBGs of the first TB.

In some aspects, the first TB includes a total number of CBs; and based on the quantity of CBGs of the first TB and the total number of CBs of the first TB, the indication of the quantity of CBGs of the first TB indicates a quantity of CBs per CBG.

In some aspects, the method 900 further includes receiving the first TB based on the CBG configuration. In some cases, the operations of this step refer to, or may be performed by, circuitry for receiving and/or code for receiving as described with reference to FIG. 11.

In some aspects, the method 900 further includes transmitting a respective acknowledgement (ACK) indication or respective negative acknowledgement (NACK) indication for each CBG of the first TB. In some cases, the operations of this step refer to, or may be performed by, circuitry for transmitting and/or code for transmitting as described with reference to FIG. 11.

In some aspects, a quantity of respective ACK indications and respective NACK indications is equal to the quantity of CBGs of the first TB.

In some aspects, the method 900 further includes determining the CBG configuration as a function of the indicated channel metric. In some cases, the operations of this step refer to, or may be performed by, circuitry for determining and/or code for determining as described with reference to FIG. 11.

In some aspects, the method 900 further includes receiving a message, from the network entity, confirming or denying the CBG configuration. In some cases, the operations of this step refer to, or may be performed by, circuitry for receiving and/or code for receiving as described with reference to FIG. 11.

In some aspects, the method 900 further includes receiving an updated policy for determining an updated CBG configuration for a second TB, wherein the updated policy comprises an indication of at least one of: an updated channel metric for determining the updated CBG configuration, or an updated conservativity level for determining the updated CBG configuration. In some cases, the operations of this step refer to, or may be performed by, circuitry for receiving and/or code for receiving as described with reference to FIG. 11.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

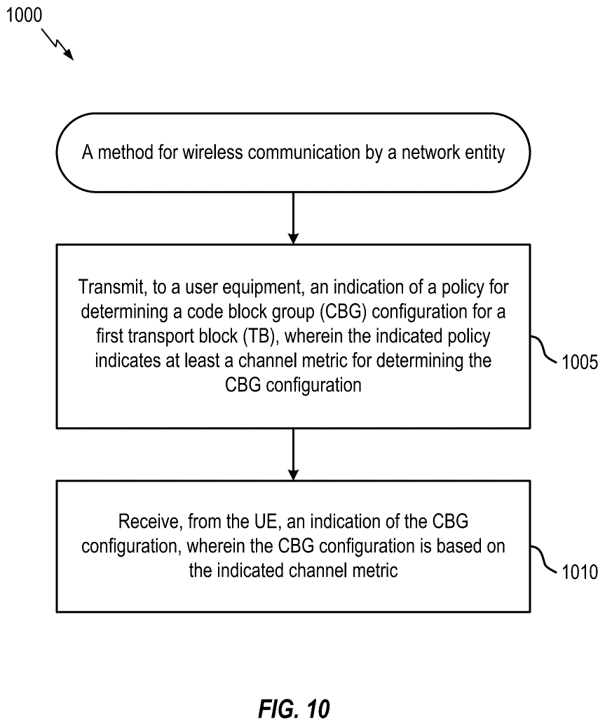

FIG. 10 shows an example of a method 1000 of wireless communication at a network entity, such as a BS 102 of FIGS. 1 and 3, or a disaggregated base station as discussed with respect to FIG. 2.

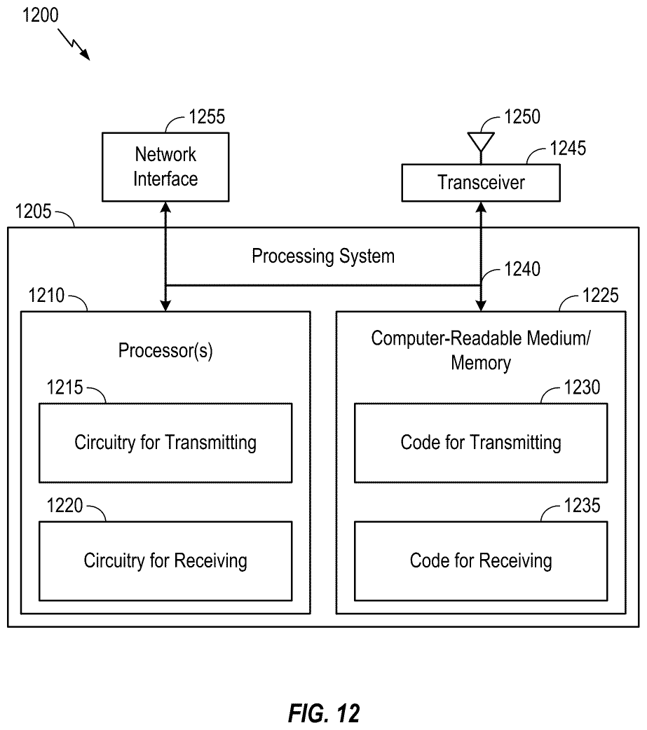

Method 1000 begins at step 1005 with transmitting, to a user equipment (UE), an indication of a policy for determining a code block group (CBG) configuration for a first transport block (TB), wherein the indicated policy indicates at least a channel metric for determining the CBG configuration. In some cases, the operations of this step refer to, or may be performed by, circuitry for transmitting and/or code for transmitting as described with reference to FIG. 12.

Method 1000 then proceeds to step 1010 with receiving, from the UE, an indication of the CBG configuration, wherein the CBG configuration is based on the indicated channel metric. In some cases, the operations of this step refer to, or may be performed by, circuitry for receiving and/or code for receiving as described with reference to FIG. 12.

In some aspects, the indicated channel metric comprises one of: a code block error ratio (CBER); a channel capacity; a delay spread; or a mobility level of the UE.

In some aspects, the method 1000 further includes transmitting, to the UE, a first message requesting capability information of the UE indicating a set of channel metrics that the UE is capable of determining. In some cases, the operations of this step refer to, or may be performed by, circuitry for transmitting and/or code for transmitting as described with reference to FIG. 12.

In some aspects, the method 1000 further includes receiving, from the UE, a second message including capability information of the UE indicating the set of channel metrics that the UE is capable of determining. In some cases, the operations of this step refer to, or may be performed by, circuitry for receiving and/or code for receiving as described with reference to FIG. 12.

In some aspects, the indicated channel metric is based on the set of channel metrics.

In some aspects, the policy further provides a conservativity level for determining the CBG configuration; and the CBG configuration is further based on the conservativity level.

In some aspects, the conservativity level indicates: a plurality of different ranges of the channel metric; and a corresponding quantity of CBGs for each different range of the plurality of different ranges.

In some aspects, the conservativity level indicates a quantity of CBGs of the first TB for the CBG configuration as a function of the channel metric.

In some aspects, the indication of the policy comprises an index value to a look up table (LUT) including a plurality of different policies for determining the CBG configuration.

In some aspects, the CBG configuration indicates a quantity of code blocks (CBs) per CBG.

In some aspects, the first TB includes a total number of CBs; and based on the quantity of CBs per CBG and the total number of CBs of the first TB, the indication of the quantity of CBs per CBG indicates a quantity of CBGs of the first TB.

In some aspects, the CBG configuration indicates a quantity of CBGs of the first TB.

In some aspects, the first TB includes a total number of CBs; and based on the quantity of CBGs of the first TB and the total number of CBs of the first TB, the indication of the quantity of CBGs of the first TB indicates a quantity of CBs per CBG.

In some aspects, the method 1000 further includes transmitting, to the UE, the first TB based on the CBG configuration. In some cases, the operations of this step refer to, or may be performed by, circuitry for transmitting and/or code for transmitting as described with reference to FIG. 12.

In some aspects, the method 1000 further includes receiving a respective acknowledgement (ACK) indication or respective negative acknowledgement (NACK) indication for each CBG of the first TB. In some cases, the operations of this step refer to, or may be performed by, circuitry for receiving and/or code for receiving as described with reference to FIG. 12.

In some aspects, a quantity of respective ACK indications and respective NACK indications is equal to the quantity of CBGs of the first TB.

In some aspects, the CBG configuration is a function of the indicated channel metric.

In some aspects, the method 1000 further includes transmitting a message, to the UE, confirming or denying the CBG configuration. In some cases, the operations of this step refer to, or may be performed by, circuitry for transmitting and/or code for transmitting as described with reference to FIG. 12.

In some aspects, the method 1000 further includes transmitting, to the UE, an updated policy for determining an updated CBG configuration for a second TB, wherein the updated policy comprises an indication of at least one of: an updated channel metric for determining the updated CBG configuration, or an updated conservativity level for determining the updated CBG configuration. In some cases, the operations of this step refer to, or may be performed by, circuitry for transmitting and/or code for transmitting as described with reference to FIG. 12.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1155 (e.g., a transmitter and/or a receiver). The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for receiving 1135, code for determining 1140, and code for transmitting 1145. Processing of the code for receiving 1135, code for determining 1140, and code for transmitting 1145 may cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry such as circuitry for receiving 1115, circuitry for determining 1120, and circuitry for transmitting 1125. Processing with circuitry for receiving 1115, circuitry for determining 1120, and circuitry for transmitting 1125 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1155 and the antenna 1160 of the communications device 1100 in FIG. 11. Means for receiving or obtaining may include transceivers 354 and/or antenna(s) 352 of the UE 104 illustrated in FIG. 3 and/or the transceiver 1155 and the antenna 1160 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1245 (e.g., a transmitter and/or a receiver) and/or a network interface 1255. The transceiver 1245 is configured to transmit and receive signals for the communications device 1200 via the antenna 1250, such as the various signals as described herein. The network interface 1255 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1225 stores code (e.g., executable instructions), such as code for transmitting 1230 and code for receiving 1235. Processing of the code for transmitting 1230 and code for receiving 1235 may cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry such as circuitry for transmitting 1215 and circuitry for receiving 1220. Processing with circuitry for transmitting 1215 and circuitry for receiving 1220 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1245 and the antenna 1250 of the communications device 1200 in FIG. 12. Means for receiving or obtaining may include transceivers 332 and/or antenna(s) 334 of the BS 102 illustrated in FIG. 3 and/or the transceiver 1245 and the antenna 1250 of the communications device 1200 in FIG. 12.

### Example Clauses

Implementation examples are described in the following numbered clauses:
Clause 1: A method for wireless communication by a user equipment (UE), comprising: receiving, from a network entity, an indication of a policy for determining a code block group (CBG) configuration for a first transport block (TB), wherein the indicated policy indicates at least a channel metric for determining the CBG configuration; determining the indicated channel metric based on the indicated policy and one or more channel measurements; and transmitting, to the network entity, an indication of the CBG configuration, wherein the CBG configuration is based on the determined channel metric.
Clause 2: The method of Clause 1, wherein the indicated channel metric comprises one of: a code block error ratio (CBER); a channel capacity; a delay spread; or a mobility level of the UE.
Clause 3: The method of any one of Clauses 1-2, further comprising: receiving, from the network entity, a first message requesting capability information of the UE indicating a set of channel metrics that the UE is capable of determining; and transmitting a second message including capability information of the UE indicating the set of channel metrics that the UE is capable of determining.
Clause 4: The method of Clause 3, wherein the indicated channel metric is based on the set of channel metrics.
Clause 5: The method of any one of Clauses 1-4, wherein: the policy further provides a conservativity level for determining the CBG configuration; and the CBG configuration is further based on the conservativity level.
Clause 6: The method of Clause 5, wherein the conservativity level indicates: a plurality of different ranges of the channel metric; and a corresponding quantity of CBGs for each different range of the plurality of different ranges.
Clause 7: The method of Clause 5, wherein the conservativity level indicates a quantity of CBGs of the first TB for the CBG configuration as a function of the channel metric.
Clause 8: The method of any one of Clauses 1-7, wherein: the indication of the policy comprises an index value to a look up table (LUT) including a plurality of different policies for determining the CBG configuration; and the method further comprises determining the policy based on the index value and the LUT.
Clause 9: The method of any one of Clauses 1-8, wherein the CBG configuration indicates a quantity of code blocks (CBs) per CBG.
Clause 10: The method of Clause 9, wherein: the first TB includes a total number of CBs; and based on the quantity of CBs per CBG and the total number of CBs of the first TB, the indication of the quantity of CBs per CBG indicates a quantity of CBGs of the first TB.
Clause 11: The method of any one of Clauses 1-10, wherein the CBG configuration indicates a quantity of CBGs of the first TB.
Clause 12: The method of Clause 11, wherein: the first TB includes a total number of CBs; and based on the quantity of CBGs of the first TB and the total number of CBs of the first TB, the indication of the quantity of CBGs of the first TB indicates a quantity of CBs per CBG.
Clause 13: The method of Clause 11, further comprising: receiving the first TB based on the CBG configuration; and transmitting a respective acknowledgement (ACK) indication or respective negative acknowledgement (NACK) indication for each CBG of the first TB.
Clause 14: The method of Clause 13, wherein a quantity of respective ACK indications and respective NACK indications is equal to the quantity of CBGs of the first TB.
Clause 15: The method of any one of Clauses 1-14, further comprising determining the CBG configuration as a function of the indicated channel metric.
Clause 16: The method of any one of Clauses 1-15, further comprising receiving a message, from the network entity, confirming or denying the CBG configuration.
Clause 17: The method of any one of Clauses 1-16, further comprising receiving an updated policy for determining an updated CBG configuration for a second TB, wherein the updated policy comprises an indication of at least one of: an updated channel metric for determining the updated CBG configuration, or an updated conservativity level for determining the updated CBG configuration.
Clause 18: A method for wireless communication by a network entity, comprising: transmitting, to a user equipment (UE), an indication of a policy for determining a code block group (CBG) configuration for a first transport block (TB), wherein the indicated policy indicates at least a channel metric for determining the CBG configuration; and receiving, from the UE, an indication of the CBG configuration, wherein the CBG configuration is based on the indicated channel metric.
Clause 19: The method of Clause 18, wherein the indicated channel metric comprises one of: a code block error ratio (CBER); a channel capacity; a delay spread; or a mobility level of the UE.
Clause 20: The method of any one of Clauses 18-19, further comprising: transmitting, to the UE, a first message requesting capability information of the UE indicating a set of channel metrics that the UE is capable of determining; and receiving, from the UE, a second message including capability information of the UE indicating the set of channel metrics that the UE is capable of determining.
Clause 21: The method of Clause 20, wherein the indicated channel metric is based on the set of channel metrics.
Clause 22: The method of any one of Clauses 18-21, wherein: the policy further provides a conservativity level for determining the CBG configuration; and the CBG configuration is further based on the conservativity level.
Clause 23: The method of Clause 22, wherein the conservativity level indicates: a plurality of different ranges of the channel metric; and a corresponding quantity of CBGs for each different range of the plurality of different ranges.
Clause 24: The method of Clause 22, wherein the conservativity level indicates a quantity of CBGs of the first TB for the CBG configuration as a function of the channel metric.
Clause 25: The method of any one of Clauses 18-24, wherein the indication of the policy comprises an index value to a look up table (LUT) including a plurality of different policies for determining the CBG configuration.
Clause 26: The method of any one of Clauses 18-25, wherein the CBG configuration indicates a quantity of code blocks (CBs) per CBG.
Clause 27: The method of Clause 26, wherein: the first TB includes a total number of CBs; and based on the quantity of CBs per CBG and the total number of CBs of the first TB, the indication of the quantity of CBs per CBG indicates a quantity of CBGs of the first TB.
Clause 28: The method of any one of Clauses 18-27, wherein the CBG configuration indicates a quantity of CBGs of the first TB.
Clause 29: The method of Clause 28, wherein: the first TB includes a total number of CBs; and based on the quantity of CBGs of the first TB and the total number of CBs of the first TB, the indication of the quantity of CBGs of the first TB indicates a quantity of CBs per CBG.
Clause 30: The method of Clause 28, further comprising: transmitting, to the UE, the first TB based on the CBG configuration; and receiving a respective acknowledgement (ACK) indication or respective negative acknowledgement (NACK) indication for each CBG of the first TB.
Clause 31: The method of Clause 30, wherein a quantity of respective ACK indications and respective NACK indications is equal to the quantity of CBGs of the first TB.
Clause 32: The method of any one of Clauses 18-31, wherein the CBG configuration is a function of the indicated channel metric.
Clause 33: The method of any one of Clauses 18-32, further comprising transmitting a message, to the UE, confirming or denying the CBG configuration.
Clause 34: The method of any one of Clauses 18-33, further comprising transmitting, to the UE, an updated policy for determining an updated CBG configuration for a second TB, wherein the updated policy comprises an indication of at least one of: an updated channel metric for determining the updated CBG configuration, or an updated conservativity level for determining the updated CBG configuration.
Clause 35: An apparatus, comprising: at least one memory comprising executable instructions; and at least one processor configured to execute the executable instructions and cause the apparatus to perform a method in accordance with any combination of Clauses 1-34.
Clause 36: An apparatus, comprising means for performing a method in accordance with any combination of Clauses 1-34.
Clause 37: A non-transitory computer-readable medium comprising executable instructions that, when executed by at least one processor of an apparatus, cause the apparatus to perform a method in accordance with any combination of Clauses 1-34.
Clause 38: A computer program product embodied on a computer-readable storage medium comprising code for performing a method in accordance with any combination of Clauses 1-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
one or more processors configured to execute instructions stored on one or more memories and to cause the UE to:
receive, from a network entity, an indication of a policy for determining a code block group (CBG) configuration for a first transport block (TB), wherein the indicated policy indicates at least a channel metric for determining the CBG configuration;
determine the indicated channel metric based on the indicated policy and one or more channel measurements; and
transmit, to the network entity, an indication of the CBG configuration, wherein the CBG configuration is based on the determined channel metric.

2. The apparatus of claim 1, wherein the indicated channel metric comprises one of:
a code block error ratio (CBER);
a channel capacity;
a delay spread; or
a mobility level of the UE.

3. The apparatus of claim 1, wherein the one or more processors are further configured to cause the UE to:
receive, from the network entity, a first message requesting capability information of the UE indicating a set of channel metrics that the UE is capable of determining; and
transmit a second message including capability information of the UE indicating the set of channel metrics that the UE is capable of determining.

4. The apparatus of claim 3, wherein the indicated channel metric is based on the set of channel metrics.

5. The apparatus of claim 1, wherein:
the policy further provides a conservativity level for determining the CBG configuration; and
the CBG configuration is further based on the conservativity level.

6. The apparatus of claim 5, wherein the conservativity level indicates:
a plurality of different ranges of the channel metric; and
a corresponding quantity of CBGs for each different range of the plurality of different ranges.

7. The apparatus of claim 5, wherein the conservativity level indicates a quantity of CBGs of the first TB for the CBG configuration as a function of the channel metric.

8. The apparatus of claim 1, wherein:
the indication of the policy comprises an index value to a look up table (LUT) including a plurality of different policies for determining the CBG configuration; and
the one or more processors are configured to cause the UE to determine the policy based on the index value and the LUT.

9. The apparatus of claim 1, wherein the CBG configuration indicates a quantity of code blocks (CBs) per CBG.

10. The apparatus of claim 9, wherein:
the first TB includes a total number of CBs; and
based on the quantity of CBs per CBG and the total number of CBs of the first TB, the indication of the quantity of CBs per CBG indicates a quantity of CBGs of the first TB.

11. The apparatus of claim 1, wherein the CBG configuration indicates a quantity of CBGs of the first TB.

12. The apparatus of claim 11, wherein:
the first TB includes a total number of CBs; and
based on the quantity of CBGs of the first TB and the total number of CBs of the first TB, the indication of the quantity of CBGs of the first TB indicates a quantity of CBs per CBG.

13. The apparatus of claim 11, wherein the one or more processors are further configured to cause the UE to:
receive the first TB based on the CBG configuration; and
transmit a respective acknowledgement (ACK) indication or respective negative acknowledgement (NACK) indication for each CBG of the first TB.

14. The apparatus of claim 13, wherein a quantity of respective ACK indications and respective NACK indications is equal to the quantity of CBGs of the first TB.

15. The apparatus of claim 1, wherein the one or more processors are configured to cause the UE to determine the CBG configuration as a function of the indicated channel metric.

16. The apparatus of claim 1, wherein the one or more processors are further configured to cause the UE to receive a message, from the network entity, confirming or denying the CBG configuration.

17. The apparatus of claim 1, wherein:
the one or more processors are further configured to cause the UE to receive an updated policy for determining an updated CBG configuration for a second TB; and
the updated policy comprises an indication of at least one of:
an updated channel metric for determining the updated CBG configuration; or
an updated conservativity level for determining the updated CBG configuration.

18. An apparatus for wireless communication at a network entity, comprising:
one or more processors configured to execute instructions stored on one or more memories and to cause the network entity to:
transmit, to a user equipment (UE), an indication of a policy for determining a code block group (CBG) configuration for a first transport block (TB), wherein the indicated policy indicates at least a channel metric for determining the CBG configuration; and
receive, from the UE, an indication of the CBG configuration, wherein the CBG configuration is based on the indicated channel metric.

19. The apparatus of claim 18, wherein the indicated channel metric comprises one of:
a code block error ratio (CBER);
a channel capacity;
a delay spread; or
a mobility level of the UE.

20. The apparatus of claim 18, wherein:
the one or more processors are further configured to cause the network entity to:
transmitting, to the UE, a first message requesting capability information of the UE indicating a set of channel metrics that the UE is capable of determining; and
receiving, from the UE, a second message including capability information of the UE indicating the set of channel metrics that the UE is capable of determining; and
the indicated channel metric is based on the set of channel metrics.

21. The apparatus of claim 18, wherein:
the policy further provides a conservativity level for determining the CBG configuration;
the CBG configuration is further based on the conservativity level; and
the conservativity level indicates a quantity of CBGs of the first TB for the CBG configuration as a function of the channel metric.

22. The apparatus of claim 21, wherein the conservativity level indicates:
a plurality of different ranges of the channel metric; and
a corresponding quantity of CBGs for each different range of the plurality of different ranges.

23. The apparatus of claim 18, wherein the indication of the policy comprises an index value to a look up table (LUT) including a plurality of different policies for determining the CBG configuration.

24. The apparatus of claim 18, wherein:
the CBG configuration indicates a quantity of code blocks (CBs) per CBG;
the first TB includes a total number of CBs; and
based on the quantity of CBs per CBG and the total number of CBs of the first TB, the indication of the quantity of CBs per CBG indicates a quantity of CBGs of the first TB.

25. The apparatus of claim 18, wherein:
the CBG configuration indicates a quantity of CBGs of the first TB;
the first TB includes a total number of CBs; and
based on the quantity of CBGs of the first TB and the total number of CBs of the first TB, the indication of the quantity of CBGs of the first TB indicates a quantity of CBs per CBG;
the one or more processors are further configured to cause the network entity to:
transmit, to the UE, the first TB based on the CBG configuration; and
receive a respective acknowledgement (ACK) indication or respective negative acknowledgement (NACK) indication for each CBG of the first TB;
and
a quantity of respective ACK indications and respective NACK indications is equal to the quantity of CBGs of the first TB.

26. The apparatus of claim 18, wherein the CBG configuration is a function of the indicated channel metric.

27. The apparatus of claim 18, wherein the one or more processors are further configured to cause the network entity to transmit a message, to the UE, confirming or denying the CBG configuration.

28. The apparatus of claim 18, wherein:
the one or more processors are further configured to cause the network entity to transmit, to the UE, an updated policy for determining an updated CBG configuration for a second TB; and
the updated policy comprises an indication of at least one of:
an updated channel metric for determining the updated CBG configuration; or
an updated conservativity level for determining the updated CBG configuration.

29. A method for wireless communication at a user equipment (UE), comprising:
receiving, from a network entity, an indication of a policy for determining a code block group (CBG) configuration for a first transport block (TB), wherein the indicated policy indicates at least a channel metric for determining the CBG configuration;
determining the indicated channel metric based on the indicated policy and one or more channel measurements; and
transmitting, to the network entity, an indication of the CBG configuration, wherein the CBG configuration is based on the determined channel metric.

30. A method for wireless communication at a network entity, comprising:
transmitting, to a user equipment (UE), an indication of a policy for determining a code block group (CBG) configuration for a first transport block (TB), wherein the indicated policy indicates at least a channel metric for determining the CBG configuration; and
receiving, from the UE, an indication of the CBG configuration, wherein the CBG configuration is based on the indicated channel metric.
